(19) United States
(12) Patent Application Publication
(10) Pub. No.: US 2019/0227750 A1
(43) Pub. Date: Jul. 25, 2019

(54) TECHNOLOGIES FOR PERFORMING TENSOR OPERATIONS IN MEMORY

(71) Applicant: Intel Corporation, Santa Clara, CA (US)

(72) Inventors: Srikanth Srinivasan, Portland, OR (US); Richard Coulson, Portland, OR (US); Rajesh Sundaram, Folsom, CA (US); Bruce Querbach, Hillsboro, OR (US); Jawad B. Khan, Portland, OR (US); Shigeki Tomishima, Portland, OR (US); Sriram Vangal, Portland, OR (US); Wei Wu, Portland, OR (US); Chetan Chauhan, Folsom, CA (US)

(21) Appl. No.: 16/370,007

(22) Filed: Mar. 29, 2019

(51) Int. Cl. G06F 3/06

(52) U.S. Cl. CPC G06F 3/0659; G06N 3/08; G06F 3/0679; G06F 3/0604

(57) ABSTRACT

Technologies for performing tensor operations in memory include a memory comprising media access circuitry coupled to a memory media having a cross point architecture. The media access circuitry is to access matrix data from the memory media, perform a tensor operation on the matrix data, and write, to the memory media, resultant data indicative of a result of the tensor operation.

### BACKGROUND

Artificial intelligence applications, such as processes that utilize neural networks (e.g., convolutional neural networks), primarily rely on performing matrix operations, such as matrix multiplication, matrix multiply and accumulate, and others (referred to herein as “tensor operations”) to mimic cognitive functions, such as learning (e.g., training) and making inferences (e.g., deducing new information from a set of known information, such as recognizing an object depicted in a new image based on identifications of the object in previous images). Given that the contents of a matrix are located in memory, performing a tensor operation involves moving the matrix data from the memory to the processor (e.g., through a bus), performing a tensor operation on the matrix data (e.g., matrix multiplication) with the processor, and sending the resultant data back to the memory. The communication of the data between the memory and the processor (e.g., through a bus) consumes a significant amount of power and time and limits the efficiency with which artificial intelligence operations can be performed.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified diagram of at least one embodiment of a compute device for performing tensor operations in memory;

FIG. 2 is a simplified diagram of at least one embodiment of a memory media included in the compute device of FIG. 1;

FIG. 3 is a simplified diagram of at least one embodiment of partitions of the memory media and components of a media access circuitry of a memory included in the compute device of FIG. 1;

FIG. 4 is a simplified diagram of at least one embodiment of a tensor operation that may be performed in the memory of the compute device of FIG. 1; and

FIGS. 5-6 are a simplified diagram of at least one embodiment of a method for performing tensor operations in memory that may be performed by the compute device of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

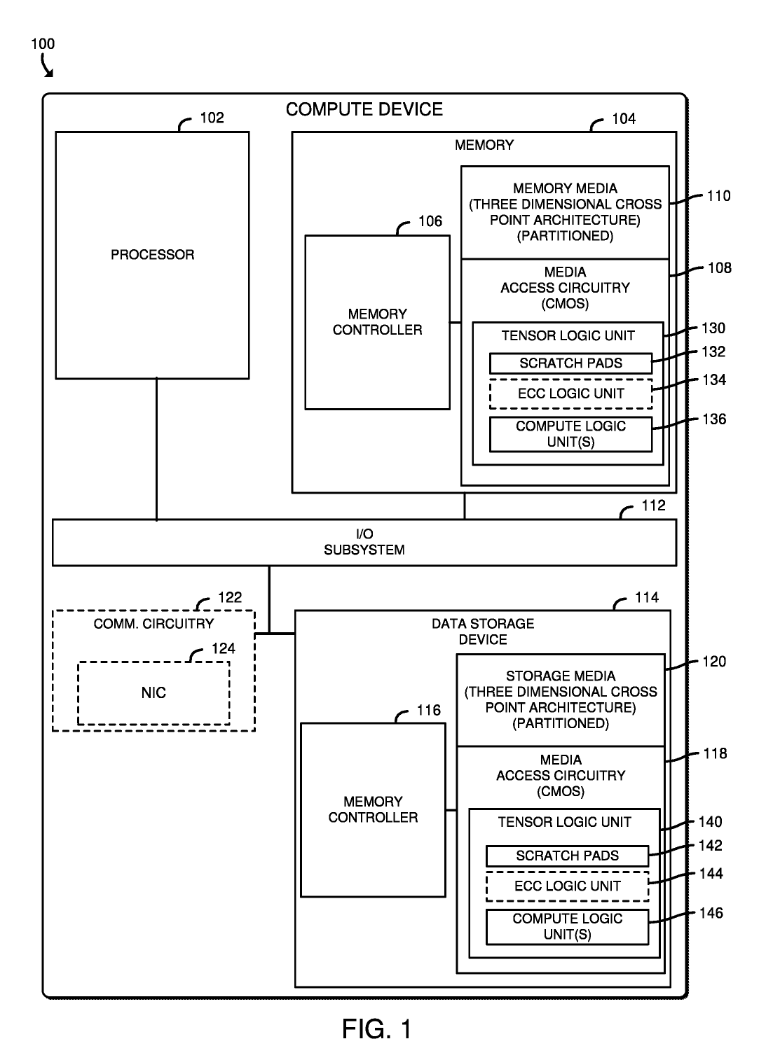

Referring now to FIG. 1, a compute device 100 for performing tensor operations in memory includes a processor 102, memory 104, an input/output (I/O) subsystem 112, a data storage device 114, and communication circuitry 122. Of course, in other embodiments, the compute device 100 may include other or additional components, such as those commonly found in a computer (e.g., a display, peripheral devices, etc.). Additionally, in some embodiments, one or more of the illustrative components may be incorporated in, or otherwise form a portion of, another component. As described herein, the compute device 100, and in particular, the memory 104 of the compute device 100 enables tensor operations (e.g., matrix calculations) to be performed more efficiently than in conventional compute devices by performing the operations in the memory 104. The compute device 100, in the illustrative embodiment, performs the tensor operations using media access circuitry 108, which accesses the memory media 110, in which the matrix data is stored, rather than expending the time and energy to communicate the matrix data between the memory 104 and the processor 102. In some embodiments the media access circuitry 108 is included in the same die as the memory media 110. In other embodiments, the media access circuitry 108 is on a separate die but in the same package as the memory media 110. In yet other embodiments, the media access circuitry 108 is in a separate die and separate package but on the same dual in-line memory module (DIMM) or board as the memory media 110.

The processor 102 may be embodied as any device or circuitry (e.g., a multi-core processor(s), a microcontroller, or other processor or processing/controlling circuit) capable of performing operations described herein, such as executing an application (e.g., an artificial intelligence related application that may utilize a neural network or other machine learning structure to learn and make inferences). In some embodiments, the processor 102 may be embodied as, include, or be coupled to an FPGA, an application specific integrated circuit (ASIC), reconfigurable hardware or hardware circuitry, or other specialized hardware to facilitate performance of the functions described herein.

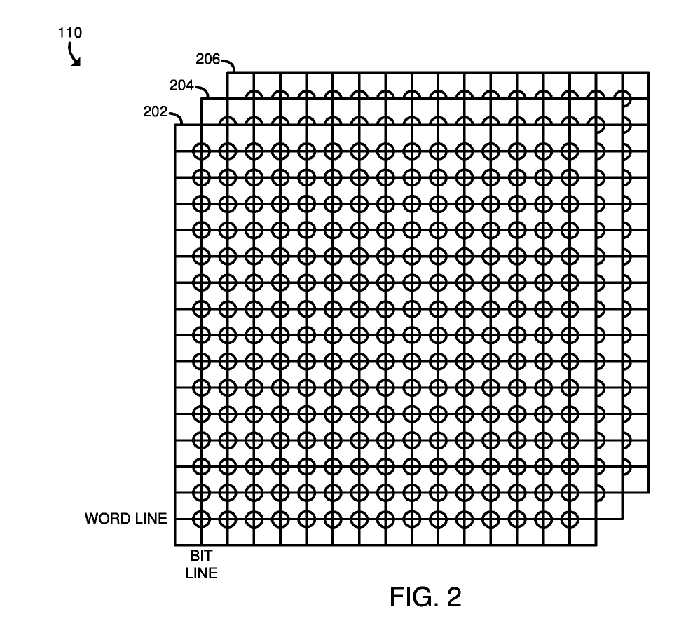

The memory 104, which may include a non-volatile memory (e.g., a far memory in a two-level memory scheme), includes a memory media 110 and media access circuitry 108 (e.g., a device or circuitry, such as integrated circuitry constructed from complementary metal-oxide-semiconductors (CMOS) or other materials) underneath (e.g., at a lower location) and coupled to the memory media 110. The media access circuitry 108 is also connected to a memory controller 106, which may be embodied as any device or circuitry (e.g., a processor, a co-processor, dedicated circuitry, etc.) configured to selectively read from and/or write to the memory media 110 and to perform tensor operations on data (e.g., matrix data) present in the memory media 110 (e.g., in response to requests from the processor 102, which may be executing an artificial intelligence related application that relies on tensor operations to train a neural network and/or to make inferences). Referring briefly to FIG. 2, the memory media 110, in the illustrative embodiment, includes a tile architecture, also referred to herein as a cross point architecture (e.g., an architecture in which memory cells sit at the intersection of word lines and bit lines and are individually addressable and in which bit storage is based on a change in bulk resistance), in which each tile (e.g., memory cell) is addressable by an x parameter and a y parameter (e.g., a column and a row). The memory media 110 includes multiple partitions, each of which includes the tile architecture. The partitions may be stacked as layers 202, 204, 206 to form a three-dimensional cross point architecture (e.g., Intel 3D XPoint™ memory). Unlike typical memory devices, in which only fixed-size multiple-bit data structures (e.g., byte, words, etc.) are addressable, the media access circuitry 108 is configured to read individual bits, or other units of data, from the memory media 110 at the request of the memory controller 106, which may produce the request in response to receiving a corresponding request from the processor 102.

Referring back to FIG. 1, the media access circuitry 108, in the illustrative embodiment, includes a tensor logic unit 130, which may be embodied as any device or circuitry (e.g., CMOS circuitry) configured to offload the performance of tensor operations from other portions of the media access circuitry 108. The tensor logic unit 130, in the illustrative embodiment, includes multiple memory scratch pads 132, each of which may be embodied as any device or circuitry (e.g., static random access memories (SRAMs), register files, etc.) usable to provide relatively fast (e.g., low latency) access to matrix data that has been read from the memory media 110. In the illustrative embodiment, the scratch pads 132 provide faster read and write access times than the memory media 110 which has comparatively slower access times and a larger capacity. The tensor logic unit 130 may additionally include an error correction code (ECC) logic unit 134, which may be embodied as any device or circuitry (e.g., reconfigurable circuitry, an application specific integrated circuit (ASIC), etc.) configured to determine whether data read from the memory media 110 contains errors and to correct any errors with error correction algorithm(s), such as Reed-Solomon codes or Bose-Chaudhuri-Hocquenghem (BCH) codes. Additionally, in the illustrative embodiment, the tensor logic unit 136 includes multiple compute logic units 136 each of which may be embodied as any device or circuitry (e.g., reconfigurable circuitry, ASICs, etc.) configured to perform tensor operations on matrix data in a corresponding set of scratch pads 132.

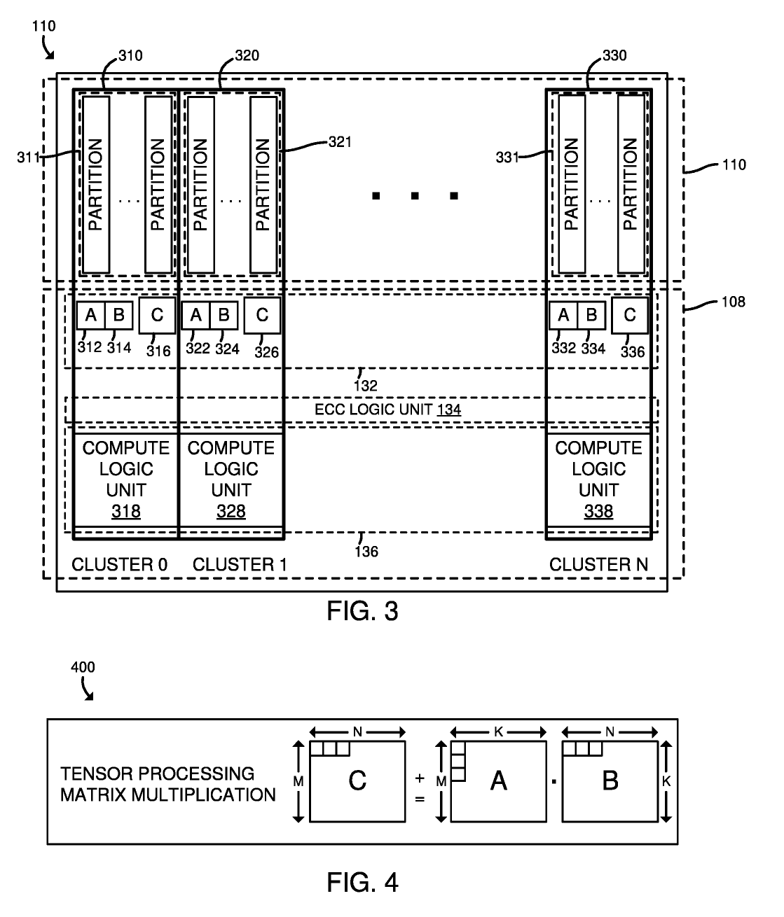

Referring briefly to FIG. 3, in the illustrative embodiment, components of the memory 104 are divided into clusters 310, 320, 330. The cluster 310 includes multiple partitions 311 of the memory media 110, a set of scratch pads 312, 314, 316, each similar to the scratch pads 132 of FIG. 1, and a corresponding compute logic unit 318, similar to the compute logic unit 136 of FIG. 1. Similarly, the cluster 320 includes another set of partitions 321 of the memory media 110, a corresponding set of scratch pads 322, 324, 326, and a corresponding compute logic unit 328. The cluster 330 also includes a set of partitions 331 of the memory media 110, a corresponding set of scratch pads 332, 334, 336, and a compute logic unit 338. In the illustrative embodiment, in operation, the compute logic unit 318 reads a subset of matrix data (e.g., one value of an input matrix A from the set of partitions (e.g., partitions 311)) into the corresponding scratch pad 312 and may broadcast that same subset of the matrix data to the corresponding scratch pads of the other clusters (e.g., to the scratch pads 322, 332). Similarly, the compute logic unit 328 may read, from the corresponding set of partitions 321 another subset of the matrix data (e.g., another value of the input matrix A) into the corresponding scratch pad 322 and broadcast that subset of the matrix data to the other scratch pads that are to store data for that matrix (e.g., to the scratch pads 312, 332). The compute logic unit 338 performs similar read and broadcast operations.

By broadcasting, to the other scratch pads, matrix data that has been read from a corresponding set of partitions of the memory media 110, the media access circuitry 108 reduces the number of times that a given section (e.g., set of partitions) of the memory media 110 must be accessed to obtain the same matrix data (e.g., the read matrix data may be broadcast to multiple scratch pads after being read from the memory media 110 once, rather than reading the same matrix data from the memory media 110 multiple times). Further, by utilizing multiple compute logic units 318, 328, 338 that are each associated with corresponding scratch pads 312, 314, 316, 322, 224, 226, 232, 234, 236, the memory access circuitry 108 may perform the portions of a tensor operation (e.g., matrix multiply and accumulate) concurrently (e.g., in parallel). It should be understood that while three clusters 310, 320, 330 are shown in FIG. 3 for simplicity, the actual number of clusters and corresponding partitions, scratch pads, and compute logic units may differ depending on the particular embodiment.

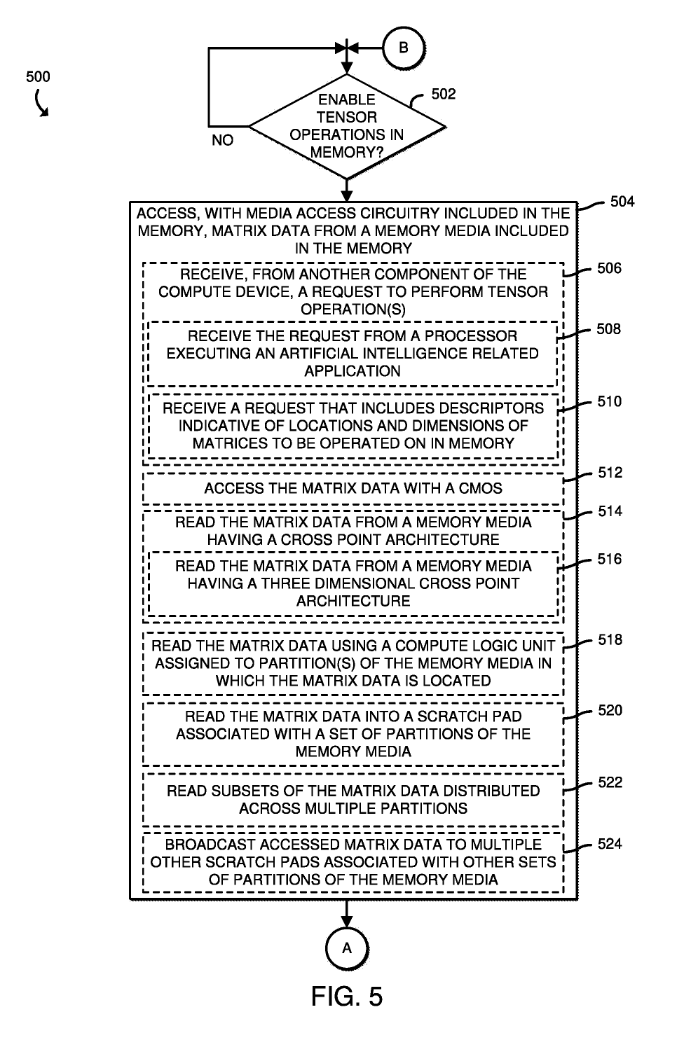

Referring briefly to FIG. 4, an example of a matrix multiplication (e.g., matrix multiply and accumulate) operation 400 that may be performed by the memory 104 is shown. As illustrated, matrix data in an input matrix A is multiplied by matrix data in another matrix B (e.g., weight data for a layer of a convolutional neural network) and the resultant data is written to the output matrix C. Each matrix represented in FIG. 4 is temporarily stored as matrix data in the scratch pads 132 of the media access circuitry 108. In some embodiments, the output matrix C may be utilized as an input matrix for a subsequent tensor operation (e.g., as an input matrix for a subsequent layer of a convolutional neural network).

Referring back to FIG. 1, the memory 104 may include non-volatile memory and volatile memory. The non-volatile memory may be embodied as any type of data storage capable of storing data in a persistent manner (even if power is interrupted to the non-volatile memory). For example, the non-volatile memory may be embodied as one or more non-volatile memory devices. The non-volatile memory devices may include one or more memory devices configured in a cross-point architecture that enables bit-level addressability (e.g., the ability to read from and/or write to individual bits of data, rather than bytes or other larger units of data), and are illustratively embodied as three-dimensional (3D) crosspoint memory. In some embodiments, the non-volatile memory may additionally include other types of memory, including any combination of memory devices that use chalcogenide phase change material (e.g., chalcogenide glass), ferroelectric transistor random-access memory (FeTRAM), nanowire-based non-volatile memory, phase change memory (PCM), memory that incorporates memristor technology, Magnetoresistive random-access memory (MRAM) or Spin Transfer Torque (STT)-MRAM. The volatile memory may be embodied as any type of data storage capable of storing data while power is supplied volatile memory. For example, the volatile memory may be embodied as one or more volatile memory devices, and is periodically referred to hereinafter as volatile memory with the understanding that the volatile memory may be embodied as other types of non-persistent data storage in other embodiments. The volatile memory may have an architecture that enables bit-level addressability, similar to the architecture described above.

The processor 102 and the memory 104 are communicatively coupled to other components of the compute device 100 via the I/O subsystem 112, which may be embodied as circuitry and/or components to facilitate input/output operations with the processor 102 and/or the main memory 104 and other components of the compute device 100. For example, the I/O subsystem 112 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 112 may form a portion of a system-on-a-chip (SoC) and be incorporated, along with one or more of the processor 102, the main memory 104, and other components of the compute device 100, in a single chip.

The data storage device 114, may be embodied as any type of device configured for short-term or long-term storage of data such as, for example, memory devices and circuits, memory cards, hard disk drives, solid-state drives, or other data storage device. In the illustrative embodiment, the data storage device 114 includes a memory controller 116, similar to the memory controller 106, storage media 120, similar to the memory media 110, and media access circuitry 118, similar to the media access circuitry 108, including a tensor logic unit 140, similar to the tensor logic unit 130, scratch pads 142, similar to the scratch pads 132, an ECC logic unit 144, similar to the ECC logic unit 134, and compute logic units 146, similar to the compute logic units 136. As such, in the illustrative embodiment, the data storage device 114 (e.g., the media access circuitry 118) is capable of efficiently performing tensor operations on matrix data stored in the storage media 120. The data storage device 114 may include a system partition that stores data and firmware code for the data storage device 114 and one or more operating system partitions that store data files and executables for operating systems.

The communication circuitry 122 may be embodied as any communication circuit, device, or collection thereof, capable of enabling communications over a network between the compute device 100 and another device. The communication circuitry 122 may be configured to use any one or more communication technology (e.g., wired or wireless communications) and associated protocols (e.g., Ethernet, Bluetooth®, Wi-Fi®, WiMAX, etc.) to effect such communication.

The illustrative communication circuitry 122 includes a network interface controller (NIC) 122, which may also be referred to as a host fabric interface (HFI). The NIC 124 may be embodied as one or more add-in-boards, daughter cards, network interface cards, controller chips, chipsets, or other devices that may be used by the compute device 100 to connect with another compute device. In some embodiments, the NIC 124 may be embodied as part of a system-on-a-chip (SoC) that includes one or more processors, or included on a multichip package that also contains one or more processors. In some embodiments, the NIC 124 may include a local processor (not shown) and/or a local memory (not shown) that are both local to the NIC 124. In such embodiments, the local processor of the NIC 124 may be capable of performing one or more of the functions of the processor 102. Additionally or alternatively, in such embodiments, the local memory of the NIC 124 may be integrated into one or more components of the compute device 100 at the board level, socket level, chip level, and/or other levels.

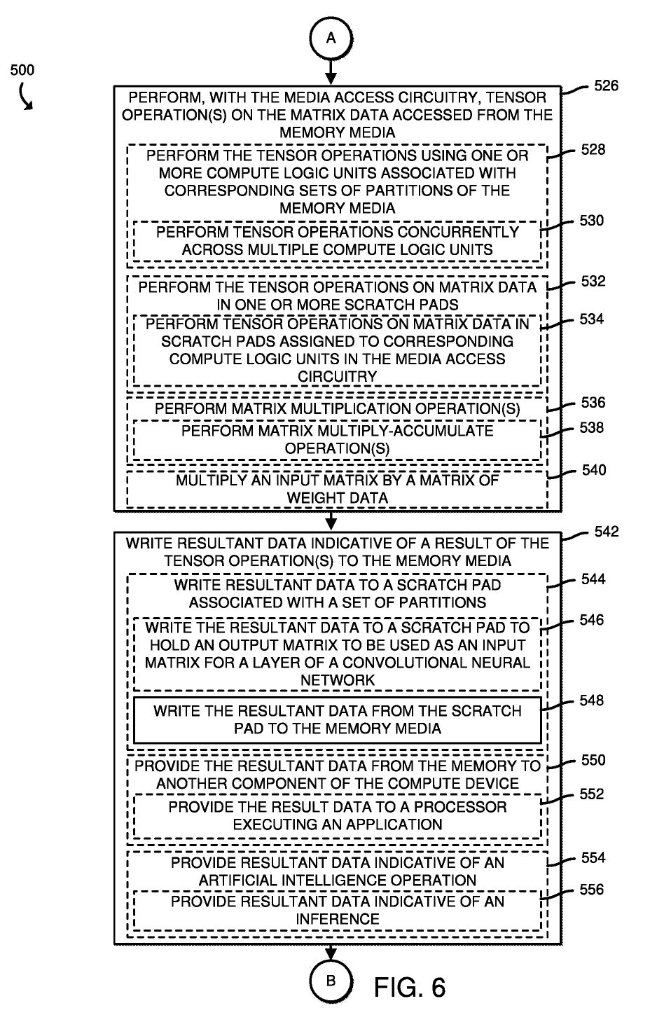

Referring now to FIG. 5, the compute device 100, in operation, may execute a method 500 for performing tensor operations in memory (e.g., in the memory 104). The method 500 is described with reference to the memory 104. However, it should be understood that the method 500 could be additionally or alternatively performed using the memory of the data storage device 114. The method 500 begins with block 502 in which the compute device 100 (e.g., the memory 104) determines whether to enable the performance of tensor operations in the memory 104. The compute device 100 may enable the performance of tensor operations in the memory 104 in response to a determination that the media access circuitry 108 includes the tensor logic unit 130, in response to a determination that a configuration setting (e.g., in a configuration file) indicates to enable the performance of tensor operations in memory, and/or based on other factors.

Regardless, in response to a determination to enable the performance of tensor operations in the memory 104, the method 500 advances to block 504, in which the compute device 100 accesses, with media access circuitry (e.g., the media access circuitry 108) included in the memory 104, matrix data from a memory media (e.g., the memory media 110) included in the memory 104. In doing so, and as indicated in block 506, the memory 104 (e.g., the media access circuitry 108) may receive, from another component of the compute device 100 a request to perform one or more tensor operations. For example, and as indicated in block 508, the memory 104 (e.g., the media access circuitry 108) may receive the request from a processor (e.g., the processor 102), which may be executing an artificial intelligence related application (e.g., an application that may utilize a neural network or other machine learning structure to learn and make inferences). As indicated in block 510, the memory 104 (e.g., the media access circuitry 108) may receive a request that includes descriptors (e.g., parameters or other data) indicative of locations (e.g., addresses) and dimensions (e.g., the number of columns and the number of rows) of matrices to be operated on in the memory 104.

Still referring to FIG. 5, in the illustrative embodiment, the compute device 100 accesses the matrix data (e.g., from the memory media 110) with a complimentary metal oxide semiconductor (CMOS) (e.g., the media access circuitry 108 may be formed from a CMOS), as indicated in block 512. Additionally, and as indicated in block 514, in the illustrative embodiment, the memory 104 (e.g., the media access circuitry 108) reads the matrix data from a memory media (e.g., the memory media 110) having a cross point architecture (e.g., an architecture in which memory cells sit at the intersection of word lines and bit lines and are individually addressable and in which bit storage is based on a change in bulk resistance). Further, and as indicated in block 516, the media access circuitry 108 may read the matrix data from a memory media (e.g., the memory media 110) having a three dimensional cross point architecture (e.g., an architecture in which sets of tiles are stacked as layers, as described with reference to FIG. 2). In the illustrative embodiment, and as indicated in block 518, the memory 104 (e.g., the memory access circuitry 108) reads the matrix data using at least one compute logic unit 136 assigned to a set of one or more partitions of the memory media 110 in which the matrix data is located. For example, the compute logic unit 318 may read matrix data from one or more of the partitions 311 included in the cluster 310 of FIG. 3.

As indicated in block 520, the memory 104 (e.g., a compute logic unit 136) may read the matrix data into a scratch pad 142 (e.g., the scratch pad 312 of the cluster 310) associated with a set of partitions (e.g., the partitions 311) of the memory media 110. In the illustrative embodiment, and as indicated in block 522, the memory 104 (e.g., media access circuitry 108) reads (e.g., with the compute logic units 136) subsets (e.g., individual values) of the matrix data distributed across multiple partitions. For example, the media access circuitry 108 (e.g., the compute logic unit 318) may read a first value of a first row of an input matrix (e.g., matrix A) from one partition and may read a second value associated with a second row of the input matrix (e.g., matrix A) from another partition, and so on. Further, and as indicated in block 524, the media access circuitry 108 (e.g., the compute logic unit 318) may broadcast the accessed matrix data to multiple other scratch pads associated with other sets of partitions of the memory media 110. For example, after reading the first value of the input matrix from a partition, the compute logic unit 318 may broadcast (e.g., provide) that read value to the scratch pads 322 and 332. By broadcasting a read value to the other scratch pads 132, the media access circuitry 108 avoids spending the time that would otherwise be needed to read the same value multiple times (e.g., once per scratch pad 132 that will need to have the value in order for the corresponding compute logic unit 136 to perform a tensor operation with the corresponding matrix). In the illustrative embodiment, the media access circuitry 108 performs the operations of block 518 through 524 for every matrix value that is needed to perform a tensor operation (e.g., a matrix multiplication operation), such as by reading values for the input matrix (e.g., matrix A) and values (e.g., weight values) for another matrix (e.g., a weight matrix, such as matrix B). Subsequently, the method 500 advances to block 526 of FIG. 6, in which the compute device 100 performs, with the media access circuitry 108, one or more tensor operations (e.g., the tensor operations requested in block 506) on the matrix data accessed from the memory media 110.

Referring now to FIG. 6, in performing the tensor operation(s), the media access circuitry 108 may perform the tensor operation(s) using one or more compute logic units associated with corresponding sets of partitions of the memory media 110 (e.g., the compute logic units 318, 328, 338), as indicated in block 528. In doing so, and as indicated in block 530, the media access circuitry 108 may perform multiple tensor operations concurrently across the compute logic units 318, 328, 338. As indicated in block 532, the media access circuitry 108, in the illustrative embodiment, performs the tensor operation(s) on matrix data in scratch pads included in the memory 104 (e.g., the scratch pads 132). In doing so, and as indicated in block 534, the media access circuity 108 performs tensor operations on matrix data in scratch pads assigned to corresponding compute logic units in the media access circuitry 108 (e.g., multiplying, with the compute logic unit 318, the matrix data in the scratch pad 312 with the matrix data in the scratch pad 314, multiplying, with the compute logic unit 328, the matrix data in the scratch pad 322 with the matrix data in the scratch pad 324, etc.). As indicated in block 536, the tensor operation(s) may be matrix multiplication operations, and as indicated in block 538, the tensor operation(s) may be matrix multiply-accumulate operations. As indicated in block 540, the media access circuitry 108 may multiply an input matrix (e.g., matrix A) by a matrix of weight data (e.g., matrix B).

Subsequently, the method 500 proceeds to block 542, in which the media access circuitry 108 writes resultant data indicative of a result of the tensor operation(s) to the memory media 110. In doing so, and as indicated in block 544, the media access circuitry 108 may initially write the resultant data to one or more scratch pads, each associated with a set of partitions of the memory media 110 (e.g., adding, to the scratch pad 316, the result of a multiplication of input matrix A from the scratch pad 312 with the weight matrix B from the scratch pad 314, adding, to the scratch pad 326, the result of a multiplication of input matrix A from the scratch pad 322 with the weight matrix B from the scratch pad 324, etc.). As indicated in block 546, the media access circuitry 108 may write the resultant data to a scratch pad (e.g., the scratch pads 316, 326, 336) to each hold an output matrix (e.g., matrix C) that is to be used as an input matrix for a layer (e.g., a subsequent layer) of a convolutional neural network. As indicated in block 548, the media access circuitry 108 writes the resultant data from the scratch pad 316, 326, 336 to the memory media 110 (e.g., to the corresponding partitions). Further, and as indicated in block 550, the memory 104 may provide the resultant data to another component of the compute device 100. For example, and as indicated in block 552, the memory 104 may provide the resultant data to the processor 102, which may be executing an application that requested the tensor operation(s) to be performed (e.g., as described relative to block 508 of FIG. 5). As indicated in block 554, the memory 104 may provide resultant data indicative of an artificial intelligence operation (e.g., the output matrix C is indicative of the result of an artificial intelligence operation). For example, and as indicated in block 556, the memory 104 may provide resultant data indicative of an inference (e.g., an identification of an object in an image, etc.). Subsequently, the method 500 loops back to block 502 of FIG. 5, in which the compute device 100 determines whether to continue to enable tensor operations (e.g., to perform further tensor operations pertaining to a subsequent layer of a convolutional neural network, to continue training a neural network, etc.).

### EXAMPLES

Illustrative examples of the technologies disclosed herein are provided below. An embodiment of the technologies may include any one or more, and any combination of, the examples described below.

Example 1 includes a memory comprising media access circuitry coupled to a memory media having a cross point architecture, wherein the media access circuitry is to access matrix data from the memory media; perform a tensor operation on the matrix data; and write, to the memory media, resultant data indicative of a result of the tensor operation.

Example 2 includes the subject matter of Example 1, and wherein the media access circuitry is a complimentary metal oxide semiconductor.

Example 3 includes the subject matter of any of Examples 1 and 2, and wherein media access circuitry includes multiple compute logic units assigned to corresponding partitions of the memory media.

Example 4 includes the subject matter of any of Examples 1-3, and wherein to access the matrix data comprises to read the matrix data using one or more of the compute logic units.

Example 5 includes the subject matter of any of Examples 1-4, and wherein to access the matrix data comprises to read the matrix data into a scratch pad associated with a set of partitions of the memory media.

Example 6 includes the subject matter of any of Examples 1-5, and wherein to access the matrix data comprises to read subsets of the matrix data distributed across multiple partitions of the memory media.

Example 7 includes the subject matter of any of Examples 1-6, and wherein to access the matrix data further comprises to broadcast, from a compute logic unit associated with a partition in which a subset of the matrix data is located, the subset of the matrix data to multiple scratch pads associated with other partitions of the memory media.

Example 8 includes the subject matter of any of Examples 1-7, and wherein the media access circuitry is further to receive, from a component of a compute device in which the memory is located, a request to perform the tensor operation.

Example 9 includes the subject matter of any of Examples 1-8, and wherein to receive a request comprises to receive a request that includes descriptors indicative of locations and dimensions of matrices to be operated on in the memory.

Example 10 includes the subject matter of any of Examples 1-9, and wherein the memory media has a three dimensional cross point architecture.

Example 11 includes the subject matter of any of Examples 1-10, and wherein the media access circuitry includes multiple compute logic units assigned to corresponding partitions of the memory media and wherein to perform the tensor operation comprises to perform multiple tensor operations concurrently with the multiple compute logic units.

Example 12 includes the subject matter of any of Examples 1-11, and wherein the media access circuitry is further to write the matrix data to scratch pads associated with the corresponding compute logic units and wherein to perform the tensor operations comprises to perform the tensor operations on the matrix data in the scratch pads.

Example 13 includes the subject matter of any of Examples 1-12, and wherein to perform a tensor operation comprises to perform a matrix multiplication operation.

Example 14 includes the subject matter of any of Examples 1-13, and wherein the media access circuitry is further to write the resultant data as an output matrix to be used as an input matrix for a subsequent tensor operation.

Example 15 includes the subject matter of any of Examples 1-14, and wherein the media access circuitry is further to provide the resultant data to a processor executing an artificial intelligence application.

Example 16 includes a method comprising accessing, by a media access circuitry included in a memory, matrix data from a memory media coupled to the media access circuitry; performing, by the media access circuitry, a tensor operation on the matrix data; and writing, by the media access circuitry and to the memory media, resultant data indicative of a result of the tensor operation.

Example 17 includes the subject matter of Example 16, and wherein accessing the matrix data comprises reading subsets of the matrix data distributed across multiple partitions of the memory media.

Example 18 includes the subject matter of any of Examples 16 and 17, and wherein accessing the matrix data further comprises broadcasting, from a compute logic unit associated with a partition in which a subset of the matrix data is located, the subset of the matrix data to multiple scratch pads associated with other partitions of the memory media.

Example 19 includes the subject matter of any of Examples 16-18, and further including writing, by the media access circuitry, the matrix data to static random access memories included in the memory and associated with corresponding compute logic units included in the media access circuitry, and wherein performing the tensor operation comprises performing, with the compute logic units, multiple the tensor operations on the matrix data in the scratch pads.

Example 20 includes one or more machine-readable storage media comprising a plurality of instructions stored thereon that, in response to being executed, cause media access circuitry included in a memory to access matrix data from a memory media coupled to the media access circuitry; perform a tensor operation on the matrix data; and write, to the memory media, resultant data indicative of a result of the tensor operation.

1. A memory comprising:
media access circuitry coupled to a memory media having a cross point architecture, wherein the media access circuitry is to:
access matrix data from the memory media;
perform a tensor operation on the matrix data; and
write, to the memory media, resultant data indicative of a result of the tensor operation.

2. The memory of claim 1, wherein the media access circuitry is a complimentary metal oxide semiconductor.

3. The memory of claim 1, wherein media access circuitry includes multiple compute logic units assigned to corresponding partitions of the memory media.

4. The memory of claim 3, wherein to access the matrix data comprises to read the matrix data using one or more of the compute logic units.

5. The memory of claim 1, wherein to access the matrix data comprises to read the matrix data into a scratch pad associated with a set of partitions of the memory media.

6. The memory of claim 1, wherein to access the matrix data comprises to read subsets of the matrix data distributed across multiple partitions of the memory media.

7. The memory of claim 6, wherein to access the matrix data further comprises to broadcast, from a compute logic unit associated with a partition in which a subset of the matrix data is located, the subset of the matrix data to multiple scratch pads associated with other partitions of the memory media.

8. The memory of claim 1, wherein the media access circuitry is further to receive, from a component of a compute device in which the memory is located, a request to perform the tensor operation.

9. The memory of claim 8, wherein to receive a request comprises to receive a request that includes descriptors indicative of locations and dimensions of matrices to be operated on in the memory.

10. The memory of claim 1, wherein the memory media has a three dimensional cross point architecture.

11. The memory of claim 1, wherein the media access circuitry includes multiple compute logic units assigned to corresponding partitions of the memory media and wherein to perform the tensor operation comprises to perform multiple tensor operations concurrently with the multiple compute logic units.

12. The memory of claim 11, wherein the media access circuitry is further to write the matrix data to scratch pads associated with the corresponding compute logic units and wherein to perform the tensor operations comprises to perform the tensor operations on the matrix data in the scratch pads.

13. The memory of claim 1, wherein to perform a tensor operation comprises to perform a matrix multiplication operation.

14. The memory of claim 1, wherein the media access circuitry is further to write the resultant data as an output matrix to be used as an input matrix for a subsequent tensor operation.

15. The memory of claim 1, wherein the media access circuitry is further to provide the resultant data to a processor executing an artificial intelligence application.

16. A method comprising:
accessing, by a media access circuitry included in a memory, matrix data from a memory media coupled to the media access circuitry;
performing, by the media access circuitry, a tensor operation on the matrix data; and
writing, by the media access circuitry and to the memory media, resultant data indicative of a result of the tensor operation.

17. The method of claim 16, wherein accessing the matrix data comprises reading subsets of the matrix data distributed across multiple partitions of the memory media.

18. The method of claim 17, wherein accessing the matrix data further comprises broadcasting, from a compute logic unit associated with a partition in which a subset of the matrix data is located, the subset of the matrix data to multiple scratch pads associated with other partitions of the memory media.

19. The method of claim 16, further comprising writing, by the media access circuitry, the matrix data to static random access memories included in the memory and associated with corresponding compute logic units included in the media access circuitry, and wherein performing the tensor operation comprises performing, with the compute logic units, multiple the tensor operations on the matrix data in the scratch pads.

20. One or more machine-readable storage media comprising a plurality of instructions stored thereon that, in response to being executed, cause media access circuitry included in a memory to:
access matrix data from a memory media coupled to the media access circuitry;
perform a tensor operation on the matrix data; and
write, to the memory media, resultant data indicative of a result of the tensor operation.
